(19) United States
(12) Patent Application Publication
(10) Pub. No.: US 2004/0253737 A1
(43) Pub. Date: Dec. 16, 2004

(54) Device and method for monitoring and regulating a process solution

(76) Inventors: Ralf Haberland, Cottbus (DE); Lothar Schulze, Dresden (DE)

Correspondence Address: WILLIAM COLLARD, COLLARD & ROE, P.C., 1077 NORTHERN BOULEVARD, ROSLYN, NY, 11576, US

(21) Appl. No.: 10/492,815

(22) PCT Filed: Mar. 4, 2003
(86) PCT No.: PCT/DE03/00679

(30) Foreign Application Priority Data
Mar. 5, 2002 (DE) 102 09 466.7

(51) Int. Cl. G01N 35/08

(52) U.S. Cl. 436/55; 422/62

(57) ABSTRACT

Disclosed are a device and a method for continuously monitoring and regulating a process solution or the concentration of additives in a process solution, which influence the surface tension, particularly surfactants, in permanently operating industrial cleaning, coating, and rinsing installations, based on measuring the surface tension according to the bubble pressure method. Units detecting the surface tension or the concentration of a process additive in a process solution, processing and controlling a predefined internal program flow of the device, continuously monitoring the quality of a process solution, and triggering an external unit influencing the process are coordinated by means of an intelligent computer system which independently extracts and processes process data, uses the data for modifying the program flow thereof, exchanges the data with an external process control system, and influences the process.

### TECHNICAL FIELD

The invention relates to a device and a method for continuously monitoring and regulating a process solution or the concentration of additives to a process solution, such as surfactants, salts, or alcohols, based on measuring the surface tension of the process solution according to the bubble pressure method. A process solution is particularly understood to mean cleaning, coating, and rinsing solutions in industrial production processes, which are used in baths or in jet spray or shower spray systems. This is the case, for example, in the metal-processing industry and in semiconductor production.

In the following, for the sake of simplicity, the discussion will relate to surfactants to represent all the additives that can be used in process solutions to influence the surface tension, and to industrial cleaning baths to represent all of the work processes, without thereby intending to restrict the area of use of the invention in any manner.

The task of industrial cleaning and rinsing baths is to reliably remove contaminants or cleaning residues from the surface of the goods being treated. As an example of goods to be cleaned, let a piece of sheet metal for a car body be mentioned, which has been oiled to prevent corrosion, the surface of which must subsequently be treated. Cleaners whose surfactants emulsify fats, for example, and are thereby bound, are mainly used for this purpose. The correct concentration of the free surfactants for the process is the deciding factor that determines the quality of the cleaning and rinsing result. If the surfactant concentration is too low, the cleaning result is insufficient. If the concentration is too high, the result is a high load of rinsing bath or cleaner residues. Likewise, the concentrations of surfactants and other additives that influence the surface tension of a process solution must be monitored and regulated in the galvanizing and paint-technology processes that often follow the cleaning.

Free surfactants accumulate at interfaces and lower the surface tension there. The measurement value for surface tension therefore correlates with the concentration of free surfactants in a process solution, and is suitable for monitoring the limit values to be established for a surfactant solution.

The concentration-dependent and time-dependent accumulation behavior of surfactants is taken into consideration by means of dynamic measurement methods. By means of varying the bubble lifetime and thereby the surface age of the bubbles, monitoring can take place over a wide concentration range. A measurement method that can be automated well is the bubble pressure method.

State of the Art

A device for dynamically measuring the surface tension of a solution is known from DE 196 36 644 C1, which is implemented as a mobile measurement device. In analogy to the method of maximum bubble pressure, a gas bubble is pressed through a measurement nozzle into the liquid to be examined, and the surface tension is determined from the pressure progression, independent of the insertion depth. The device has an input keyboard for operation in different operating modes, a display for monitoring the operating modes and displaying the measurement results, a pressure sensor for determining the pressure progression of the gas bubbles, a microprocessor for controlling and processing the measurements, as well as an internal power supply for all of the power consumers. With the measurement device, the surfactant content of a solution can be determined on site, very rapidly, in mobile manner. Automatic sampling, in-line measurements, or other automated intervention to change the quality of a solution to be examined, or in an industrial process sequence, are not possible using this device.

According to U.S. Pat. No. 6,085,577, the surface tension of a liquefied gas that is under pressure in a boiler, reactor, or pipe system, is also already being measured continuously with a bubble pressure tensiometer, in that the pressure difference between the pressure maximums of different measurement capillaries is measured. Another area of application is the continuous measurement of viscous liquids and liquids having a high solids content, both under pressure and in a normal environment. The measurement capillaries are installed directly in the boiler, in the reactor, or in the pipe system, and the pressure signals are passed to a measurement device by way of a line. Because of the flow of a liquid or vibrations in a boiler, etc., it is difficult to obtain measurement signals that provide accurate information, because the maximum bubble pressure at the tip of a measurement capillary is only a few millibars. No active influence on the process is provided.

From DE 41 36 442 A1, a method and a device for degreasing and cleaning metallic surfaces is known, according to which the dynamic surface tension of a sample is measured with a bubble pressure tensiometer, as the measure of a current cleaning reserve. Two measurement capillaries that have different radii and dip into the sample to the same depth are connected with a constant gas source, according to the method of the difference of the maximum bubble pressures. The measurement values are compared with a reference value that is determined by means of calibration for the cleaning agent being used. Bath additives are added as a function of the comparison result, and required maintenance work such as additional metering and treatment can be recognized. It is not disclosed how these are to be carried out.

Monitoring and regulating the surfactant content in aqueous process solutions is known from DE 198 14 500 A1. The surfactant content is determined by means of selective adsorption, electrochemically, chromatographically, by means of splitting into volatile compounds, by stripping out these volatile compounds, or by means of the addition of a reagent that changes the interaction of the sample with electromagnetic radiation in proportion to the surfactant content. Bubble pressure tensiometry is not performed.

DE 198 36 720 A1 describes monitoring and regulating cleaning baths, according to which at least the determination of the surfactant content and the determination of the load of inorganic and/or organic bound carbon or the alkalinity are carried out under program control. Depending on the result, supplemental components are metered in, and/or one or more bath maintenance measures is/are performed. In this connection, the determination of the content of surfactants is performed according to the method indicated in DE 198 14 500 A1.

According to DE 34 24 711 A1, it is furthermore known to control a cleaning system by taking into consideration the electrical conductivity of the cleaning agent being used. In this connection, advantage is taken of the fact that the conductivity of a cleaning agent changes with the degree of contamination. The difference in the conductivity between the bath influx and the bath reflux decreases as the cleaning process progresses. However, because there are many different contaminants on goods to be cleaned, and therefore the contaminant load of the bath is undefined, the conductivity alone does not permit a reliable enough conclusion with regard to the cleaning result, but also not a reliable enough conclusion with regard to the state of the process solution.

DE 43 00 514 describes a method for determining the free surfactants in aqueous oil/water emulsions, wherein the surface tension of a used emulsion is compared with that of a freshly mixed one, wherein the surface tension is put into correlation with the foaming behavior. No automated device for carrying out the method is indicated.

According to DE 100 29 505 A1, a method for determining the concentration of a detergent, a method for metering detergent, and a household washing machine for carrying out such methods are known. According to the bubble pressure method for measuring the surface tension of the detergent, an optimal detergent metering amount is determined and set internally in the washing machine. Continuous monitoring and maintenance of a detergent to be regulated for quality is not provided. There is also no communication with an external system. The control is integrated into the washing machine and is not housed in a separately configured device that functions in autarkic manner.

Presentation of the Invention

The invention is based on the task of indicating a device and a method for automatically and continuously monitoring and regulating an industrial process solution for continuously operating baths, spray cleaning systems, coating systems, and the like, which is based on a value that correlates with the surface tension as a measure of the current quality of a process solution, particularly the concentration of anionic, cationic, non-ionic, or amphoteric surfactants. The goal is the creation of an intelligent system that aims at optimal process reliability. The device is preferably supposed to be arranged close to the location of the industrial process bath, in order to avoid the complicated installation of electrical lines, liquid lines, as well as fittings, in order to allow simple monitoring of functional parameters of the device and/or of the process bath for the operating personnel of the process bath, and in order to achieve that the sample properties do not undergo any changes such as deposits or temperature changes. In order to allow the greatest possible degree of automation, the device is supposed to function in autarkic manner, and to regulate the media feed and media removal independently, for example. If desired, it is also supposed to be possible to alternately monitor and regulate several process solutions with one device.

This task is accomplished, according to the invention, by means of a device according to the characteristics of the independent claims 1 or 2, and by means of a method according to the independent claim 15. Advantageous further developments are indicated in the dependent claims.

A significant advantage of the device according to the invention is established by the fact that all of the components for monitoring and regulating an industrial process solution are brought together in an autarkic structural and functional unit. In this way, extensive planning and installation work is saved for the operator. Bath-specific values and steady-state characteristics are developed in the laboratory, in advance, and stored in the memory of the device. A controller that is integrated into the device accesses this memory during the determination of the surfactant content, the signaling of states, or the initiation of process technology measures according to the invention. The invention comprises a complex computer system which communicates with an external process control system, learns from transmitted, input, measured, and corrected values or process models, and can independently make decisions with regard to influencing the process. Since monitoring and regulating take place automatically, there is less need for personnel and maximal process reliability is achieved. The inflow and outflow of samples, the calibration of the surface tension sensor, and the cleaning of its measurement capillary, as well as the measurement, take place in completely automated manner. Generally, no random sample checks of the concentration of a process solution are performed, and instead, continuous monitoring of cleaning, rinsing, or coating processes takes place. If needed, maintenance measures for the process solution can be performed in fully automated manner. For this purpose, an external metering system is turned on by way of the external process control system and, if applicable, by way of another interface. The process-relevant measurement variables are monitored, processed, and stored in memory. Automation produces better cleaning results, while using less water and cleaner, for example, since metering in more substances no longer has to be performed empirically, for example, and produces an increase in process reliability. Several process solutions can also be monitored and regulated alternately, using one device. Other interfaces on the device serve for signaling states of one or more process sequences, and of the device itself, for the purpose of monitoring functional parameters.

### BRIEF DESCRIPTION OF THE DRAWINGS

The invention will be explained in greater detail below, using an exemplary embodiment. The drawing shows:

FIG. 1 a highly schematic front view of a device, with the housing cover open,

FIG. 2 a particularly advantageous measurement device,

FIG. 3 a particularly advantageous measurement capillary,

FIG. 4 as an example, one of many steady-state characteristics stored in the data memory of the device,

FIG. 5 a fundamental flow chart of the method of operation of the device, and

FIG. 6 a fundamental plan for connecting to a bath.

### PREFERRED WAYS OF IMPLEMENTING THE INVENTION

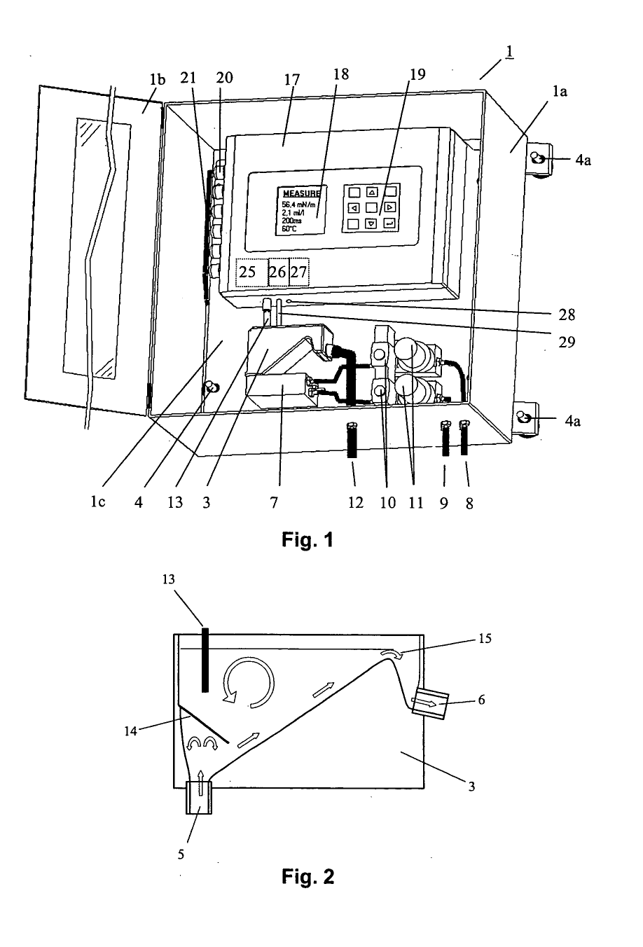

According to FIG. 1, the device, as a complex unit, is built into a robust, impact-resistant housing 1a having a door 1b, which is installed on a wall, for example, near a cleaning bath 2 (see FIG. 6) for car body parts, for example, without extensive effort and expense for planning and installation.

A measurement vessel 3 is arranged in the bottom part of the housing 1a. An installation plate 1c, which bears the measurement vessel 3, is mounted to absorb vibrations, by means of insulation material 4, in order not to transfer vibrations from the environment to a calibration liquid and a sample to be measured. In addition, the housing 1a can be installed on insulation material 4a. The measurement vessel 3 has an inflow 5 and an outflow 6. The inflow 5 is operated by way of a distributor 7. The distributor 7 assures, in interaction with valves 10, that rinsing liquid, calibration liquid, or sample flows in properly in accordance with the program. In the example, fresh water is fed in as a rinsing and calibration liquid, from an existing line network, by way of a feed connector 8. Sample flows to the measurement vessel 3 from the bath 2, by way of an inflow connector 9, either on the basis of gravitational pressure, which presupposes that the surface of the bath lies higher than the liquid level in the measurement vessel 3, or it is drawn in using a transport device, which can be installed in place of one of the valves 10, for example. In the example, the water and the sample are under pressure. The inlet is therefore controlled by a valve 10, in each instance, for both media, and regulated to a desired inlet pressure, in each instance, by means of a pressure regulator 11, if necessary. From the outflow 6, an outflow hose 12 leads back to the bath 2, in the example. If the liquid level in the measurement vessel 3 lies higher than the bath level, water as well as sample flow into the bath 2 under the effect of gravitational pressure. Accordingly, in the example, sample is passed through the measurement vessel 3 in a by-pass.

According to a particularly preferred variant, water and sample permanently flow through the covered measurement vessel 3 in the appropriate mode, in each instance. This flow-through has the advantage that the measurement vessel 3 can be rinsed well with fresh water, without making any other provisions, and that current, well-mixed sample is always available, without having to provide any complicated inflow and outflow controls from the bath 2 and back. Covering the measurement vessel 3 prevents excessive evaporation of the sample. In order to empty the measurement vessel 3 automatically, a by-pass having a small cross-section can run from the inflow 5 of the measurement vessel 3 to the outflow 6. The surface tension measurement according to the bubble pressure method requires a sample that is as quiescent as possible, and free of vibrations. In addition to the vibration-attenuated mounting of the housing 1a and the installation plate 1c, the fact that the sample is flow-stabilized in the region of the measurement capillary 13 that dips into the liquid, contributes to this.

Additional details are evident in FIG. 2. The inflow 5 to the funnel-shaped measurement vessel 3 is located at the lowest point. The inflowing liquid, water or sample, impacts off a deflector 14, and fills the measurement vessel 3 up to the level of the overflow 15. Below the overflow 15, there is the outflow 6. The measurement capillary 13 is arranged in the flow shadow of the deflector 14 and thereby in the flow-stabilized region. In order to make it easier to replace the measurement capillary 13 or for an inspection, the measurement vessel 3 is arranged so that it can be moved.

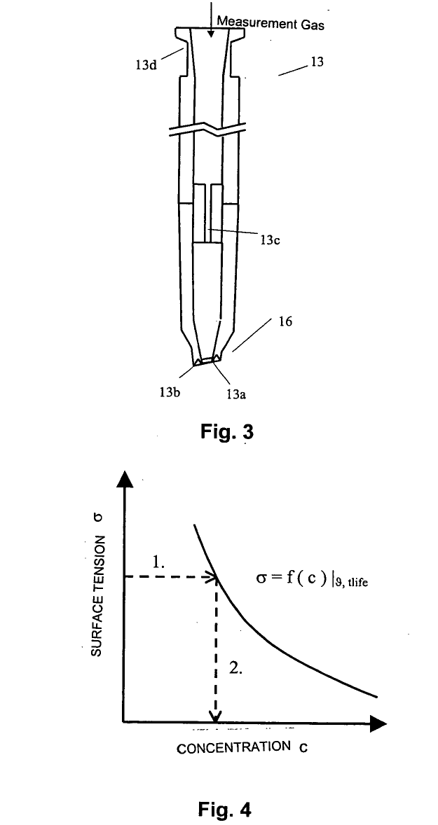

A particularly preferred embodiment of a measurement capillary 13 is described using FIG. 3. The measurement capillary 13 is injection-molded from a hydrophobic material, for example polaryl ether ketone, in order to make it non-sensitive to fracture and in order to make the penetration of sample that carries dirt more difficult. At the bubble exit opening 16, the wall 13a of the measurement capillary 13 goes towards zero, in order to preclude a bubble jump from the inside edge to the outside edge of a usual face of a measurement capillary that is hydrophobic, overall, which would lead to non-reproducible results in the evaluation of the maximum bubble pressure. In order to furthermore prevent a bubble from creeping up in the direction of the sample surface, along the outside wall of the measurement capillary 13, after the bubble pressure maximum has been exceeded and before the bubble pressure minimum has been reached at the measurement capillary 13, which would result in an unstable pressure minimum, a support ring 13b is arranged around the opening of the measurement capillary 13, over which the bubble tilts and comes loose. In equivalent manner, the face of a conventional hydrophobic measurement capillary can be notched, thereby also forming a support ring. By slanting the measurement vessel 3, or by dipping it into the measurement capillary 13 at a slant, the direction of the bubble departure can furthermore be predetermined, in order to obtain stable measurement values. Furthermore, a throttle 13c, in addition to the hydrophobic material, reduces the risk that liquid gets into the measurement capillary 13 and that vibrations that are caused by sudden changes in the bubble pressure are transferred to the interior of the measurement capillary 13, and are detected as false extreme values of the pressure during the measurement. The measurement capillary 13 is equipped with a quick-close mechanism 13d to make it easier to replace.

In accordance with FIG. 1, the electronic components for measurement, evaluation, and regulation are arranged in a moisture-proof housing 17, which furthermore contains a display 18 to display system states and measurement values, a keyboard 19, and insertions 20 for electrical lines 21 for operating current, interfaces, as well as for valves 10 and/or pumps inherent to the device.

The components for regulating a process are not integrated into the device, but rather are an integral part of the industrial cleaning, coating, or rinsing system, in each instance.

FIG. 6 shows that the device can be connected to a bath 2 very easily, in that the lines 8, 9, 12 for liquid are connected in usual manner, by means of hose connectors, and the power supply and interface lines 21 are connected with the external process control device 22, for example an SPS, and with one or more external devices 23, for example a metering pump, for regulating the process, by means of terminals. In the example, there are connections not only between the external process control system 22 and the external process regulating device(s) 23, but also between the device and the external process regulating device(s) 23. In the present example, a metering pump 23 meters in additional cleaner from a supply container 24, under control by the program.

The interfaces serve for communication with the external process control system 22 and, optionally, for direct control of external bath regulating devices 23. Therefore regulation of the process can take place both by way of the process control system 22 or, if needed, directly by the device. Other electrical interfaces, not shown in FIG. 6, serve for signaling process sequences, states of the process solution, and/or states of the device.

The measurement circuits for the surface tension measurement 25 and the temperature measurement 26 are implemented as modules and can be supplemented with measurement circuits for additional measurement variables, for which purpose preparations 27 for the measurement circuit(s) as well as mechanical preparations 28 for the corresponding sensor(s) have been provided. The additional sensors can also be integrated into the lines for liquid or into the measurement vessel. Since the surface tension is dependent on temperature, the temperature sensor 29 is arranged close to the capillary.

The dynamic surface tension of a process solution is measured according to the differential pressure method, at a measurement capillary 13, whereby the difference between the maximum bubble pressure and the minimum bubble pressure of a bubble is determined and evaluated at different surface ages, which are adjustable.

In this way, the measurement becomes independent of the insertion depth and of the measurement capillary 13 and of the density of the liquid to be measured.

Since the surface tension value, in the case of surfactant solutions, depends on the age of the surface, the bubble lifetime t_{life}, the surface tension sensor is given a reference value for the bubble lifetime from the control. An optimal steepness of the surface tension/concentration steady-state characteristic is achieved by means of a suitable selection of the bubble lifetime. If the concentration of a sample is now supposed to be determined, the surface tension, for example (or another correlating variable such as the differential pressure) is measured, it is passed from the sensor to the controller, and the controller determines the concentration, using a steady-state characteristic according to FIG. 4, from the memory. If the surface age and the temperature are constant, one such steady-state characteristic is sufficient per cleaner, otherwise these are in the memory in large numbers, or a correction of the measurement values (temperature compensation, bubble lifetime compensation) takes place. It is also possible to feed the sample in as a tempered sample, or to temper it in the vessel, in order to bring the sample to a suitable temperature. Also, it is possible to regulate the bath according to the surface tension, without determining the concentration beforehand.

A regulated source supplies the measurement capillary 13 with the required gas volume flow, in order to adjust the pre-determined surface age. It is practical if this gas is air, which is drawn in from the environment by the system. If necessary, this air can be dried first, in order to prevent the formation of condensate in the measurement capillary 13 that is dipped into a cold liquid, which would change the transmission behavior.

Since the bubble surface is usually continuously being built up when using the bubble pressure method, the adsorption equilibrium that establishes itself is disrupted, which has the result that only relatively high surfactant concentrations can be differentiated. In order to detect a surfactant effect even in solutions at a low concentration, it is possible to build up a bubble within a very short period of time and then to measure the bubble pressure as a measure for the surface tension at a constant surface.

In order to increase the reliability, particularly of the surface tension measurement and the derived measurement variables, it is possible to operate several sensors redundantly and to compare their measurement values. Another measure to achieve this purpose is to eliminate contaminants that are adhering to the measurement capillary 13, by using an ultrasound emitter, which is optionally installed in the measurement vessel 3, close to the measurement capillary 13.

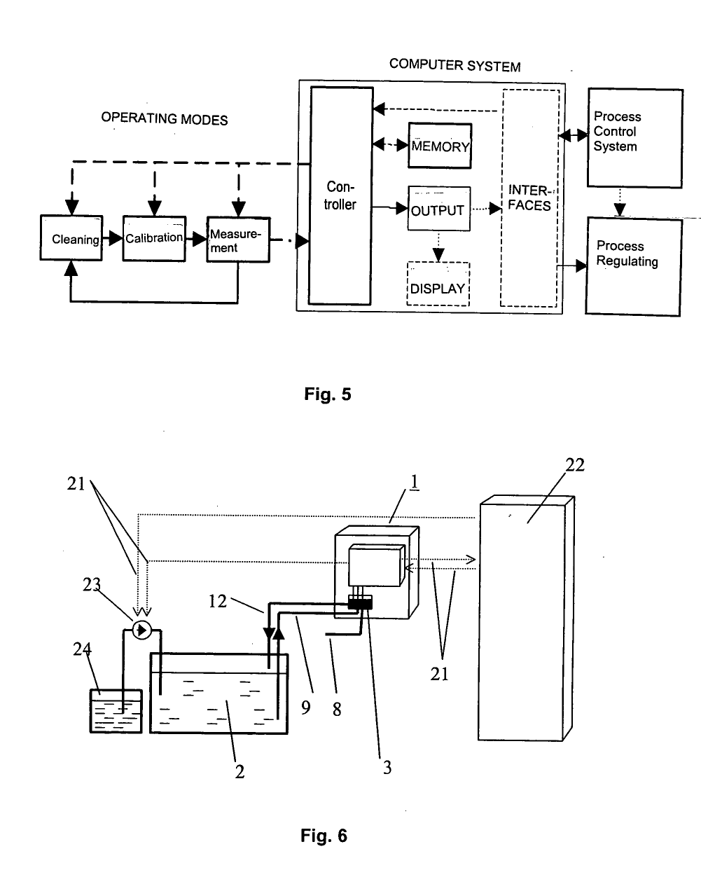

FIG. 5, in combination with FIG. 1 and FIG. 6, illustrates the method of operation of the device. After the device has been turned on, it starts to pass water through the measurement vessel 3. This mode is referred to as “cleaning” When this is done, contaminants, particularly those of a surfactant type, are flushed out, which process is monitored by the surface tension sensor, consisting of the measurement capillary 13 and the measurement circuit 25. If no change in the surface tension value can be detected any longer, the surface tension sensor 13, 25 is calibrated in this water, the surface tension of which is dependent only on the temperature, using the temperature measured by the temperature sensor 29. The point in time for a calibration is determined by the controller, or predetermined. In place of the inflow valve 10 for the water, the valve 10 for the inflow of sample is then turned on. If the sample is not under pressure, a pump can also be turned on; this is a technical equivalent.

If the changes in temperature and surface tension of the process solution that is flowing through and is to be checked for quality go below values that can be predetermined, valid measurement values are detected and processed by the integrated sensors 13, 25, 26, 29 (measurement mode), the measurement values and/or derived signals are output to displays (display 18) and/or interfaces. A sequence control of the modes, the processing of the measurement values, and communication with the external process control system 22 and, if applicable, control of external process regulating devices 23, are preset by the controller, and for this reason, a software that can be modified is included.

The device contains an internal memory for storing the firmware, adjustment values of the device, measurement values and the circumstances under which they were obtained, such as calibration values, chronological data, as well as data concerning function and self-monitoring. Additional parameters of the pressure signal, such as the actual bubble lifetime of the bubble build-up, the progression of the bubble build-up in the bubble (evidence of contamination of the capillary), the absolute pressure portion of the differential pressure signal (indication of the need to replace the measurement capillary 13 due to clogging), etc., can be used for self-monitoring, for example. In case of an error, the error is reported by way of the display 18, interfaces, or warning lights.

### Reference Symbol List

1 functional and structural unit of the device

1a housing

1b housing door, can be closed (locked)

1c installation plate in the housing

2 cleaning bath

3 measurement vessel

4 insulation material of the installation plate

4a insulation material of the housing

5 inflow

6 outflow

7 distributor

8 inflow connector for fresh water from the piping network

9 inflow connector for sample(s)

10 valve

11 pressure regulator

12 outflow hose from the measurement vessel

13 measurement capillary

13a wall of the measurement capillary at the bubble exit site

13b support ring

13c throttle

13d quick-close mechanism

14 deflector

15 overflow

16 bubble exit opening

17 moisture-proof electronic housing

18 display

19 keyboard

20 moisture-proof cable insertion

21 connection lines for operating current, interfaces, as well as valves and/or pumps inherent to the device

22 process control system of a cleaning system (SPS)

23 device(s) for regulating the process (e.g. metering pump for metering the cleaner into the cleaning bath) of a cleaning system

24 cleaner (concentrate) supply

25 measurement module for surface tension, including a regulated source for the gas volume flow

26 measurement module for the temperature measurement

27 preparation for additional measurement module(s)

28 free bore(s) for additional sensor(s)

29 temperature sensor

1. Device for continuously monitoring and regulating a process solution or the concentration of additives to a process solution, particularly surfactants, in continuously operating industrial cleaning, coating, and rinsing systems, based on measuring the surface tension of the process solution according to the bubble pressure method, wherein units for detecting the surface tension or the concentration of a process additive in process solution, for processing and regulating a predefined internal program sequence of the device, and for continuously monitoring the quality of process solution, and turning on an external device (23) that influences the process, are coordinated by means of an intelligent computer system that independently extracts and processes process data, uses said data for modifying its program sequence, exchanges the data with an external process control system (22), and influences the process, wherein the computer system contains the following memory contents in a memory, which contents can be preset by the process control system, manually, and/or by the device itself:
process sequences for cleaning, calibration, and measurement at various bubble lifetimes,
algorithms for extracting and processing measurement values, calibration curves, and cleaner-specific concentration series, and
inherent measurement values, including the circumstances under which they were extracted.

2. Device for continuously monitoring and regulating a process solution or the concentration of additives to a process solution, particularly surfactants, in continuously operating industrial cleaning, coating, and rinsing systems, based on measuring the surface tension of samples of the process solution according to the bubble pressure method, wherein units for automatically detecting the surface tension or the concentration of a process additive in process solution, for automatically processing and regulating a predefined internal program sequence of the device, and for automatically and continuously monitoring the quality of process solution, and automatically turning on an external device (23) that influences the process, and for automatic communication with an external process control system (22) are brought together, both functionally and structurally, to form an autarkic unit (1) in a housing (1a), and wherein the device for detecting the surface tension or the concentration of process additive at least comprises:
a measurement vessel (3) having a program-controlled inflow and outflow supply device (7, 10, 11) for a program-appropriate exchange of rinsing liquid, calibration liquid, and sample(s) in the measurement vessel (3),
a measurement capillary (13) in the measurement vessel (3),
a program-controlled supply device for supplying the measurement capillary (13) with measurement gas,
a pressure sensor for determining parameters of the bubble pressure of the gas bubbles that exit from the measurement capillary (13), in the calibration liquid and in sample(s),
connectors/interfaces (21) for electrical operating current, for signaling states of the device, of process sequences and/or or process solution, for the external process control system (22), as well as for hoses/pipes (8, 9, 12) for liquids.

3. Device according to claim 2, characterized in that
the measurement vessel (3) has cleaning liquid, calibration liquid, and sample(s) flowing through it, one after the other, in the cleaning mode, the calibration mode, and the measurement mode, in accordance with the program.

4. Device according to claim 2, characterized in that
the measurement vessel (3) is structured in flow-minimized manner in the region of the measurement capillary (13).

5. Device according to claim 2, characterized in that
the measurement vessel (3) holds diverted sample of a process solution in the measurement mode of the device, or diverted samples of several process solutions, in alternating manner.

6. Device according to claim 2, characterized in that
sample and/or cleaning liquid and/or calibration liquid run into the measurement vessel (3) under program control, under gravitational pressure or transport pressure or line pressure, and that the media flow out of the measurement vessel (3) by means of gravitational pressure or transport pressure.

7. Device according to claim 2, characterized in that
the device for detecting the surface tension is mounted in such a manner that it is uncoupled from vibrations.

8. Device according to claim 2, characterized in that
the measurement capillary (13) is attached by means of a quick-close mechanism (13d), so as to be easily replaceable.

9. Device according to claim 2, characterized in that
the measurement capillary (13) is hydrophobic, is slanted relative to the sample surface at the bubble exit, and has a support ring (13b) for bubbles that tip off.

10. Device according to claim 2, characterized in that
an ultrasound emitter is arranged in the measurement vessel (3) for impacting the measurement capillary (13) with ultrasound, in the cleaning mode.

11. Device according to claim 2, characterized in that
a temperature sensor (29) is arranged close to the capillary.

12. Device according to claim 2, characterized in that
additional sensors for detecting additional measurement variables, such as conductivity, turbidity, and pH are integrated into the device, and processed by the latter.

13. Device according to claim 2, characterized in that
a display and control panel (18, 19) for displaying and calling up measurement values and system states is arranged in the housing (1a).

14. Device according to claim 2, characterized in that
one or more interfaces (21) for directly connecting one or more external process regulating devices (23) is/are provided.

15. Method for continuously monitoring and regulating a process solution or the concentration of additives to a process solution, particularly surfactants, in continuously operating industrial cleaning, coating, and rinsing systems, based on measuring the surface tension of the process solution according to the bubble pressure method, using a device according to claim 2, wherein the dynamic surface tension of a process solution is automatically measured according to a differential pressure method, at a measurement capillary (13), in that the difference between the maximum bubble pressure and the minimum bubble pressure of a bubble is detected and evaluated at different surface ages that can be set.

16. Method according to claim 15, wherein a process solution is automatically measured according to a method in which the bubble surface of a bubble is kept constant.

17. Method according to claim 15, characterized in that
several similar sensors provide redundant measurement values for at least one measurement variable.

18. Method according to claim 15, characterized in that
standing or flowing sample(s) is/are tempered before the measurement.

19. Method according to claim 15, characterized in that
several process solutions are alternately monitored and regulated with a single device.
